(19) United States
(12) Patent Application Publication
(10) Pub. No.: US 2025/0014280 A1
(43) Pub. Date: Jan. 9, 2025

(54) INFORMATION PROCESSING APPARATUS, DATA GENERATION METHOD, AND NON-TRANSITORY COMPUTER-READABLE STORAGE MEDIUM

(71) Applicant: NEC Corporation, Tokyo (JP)

(72) Inventors: Takanori SHIGETA, Tokyo (JP); Akira TSUJI, Tokyo (JP); Shigeo SUZUKI, Tokyo (JP); Yusuke KUNII, Tokyo (JP); Hiroshi MATSUMOTO, Tokyo (JP); Ryusuke IMAI, Tokyo (JP)

(73) Assignee: NEC Corporation, Tokyo (JP)

(21) Appl. No.: 18/753,043

(22) Filed: Jun. 25, 2024

(30) Foreign Application Priority Data
Jul. 7, 2023 (JP) 2023-112633

(51) Int. Cl. G06T 17/20

(52) U.S. Cl. CPC G06T 17/20

(57) ABSTRACT

An object of the present invention is to provide an information processing apparatus being capable of suppressing an increase in capacity and preventing a decrease in accuracy of a shape of an object when generating image data based on point cloud data. The information processing apparatus according to the present disclosure includes: an identification unit that identifies a shape of an object included in point cloud data; a generation unit that generates first mesh data of a first object whose shape is identified, and generates second mesh data of a second object whose shape is identified, by using a mesh resolution different from a mesh resolution used in generating the first mesh data; and an integration unit that generates three-dimensional data acquired by combining the first mesh data and the second mesh data.

### INCORPORATION BY REFERENCE

This application is based upon and claims the benefit of priority from Japanese patent application No. 2023-112633, filed on Jul. 7, 2023, the disclosure of which is incorporated herein in its entirety by reference.

### TECHNICAL FIELD

The present disclosure relates to an information processing apparatus, a data generation method, and a program.

### BACKGROUND ART

When inspecting a facility installed in a substation, inspection of the facility may be performed by using an image being captured by using a sensor such as light detection and ranging (LiDAR). A person who performs inspection of a facility confirms a solid shape of each facility, and decides normality of the facility. For example, a person who performs inspection of a facility decides the normality of the facility by confirming a solid shape indicated by mesh data generated based on point cloud data generated by using a LiDAR or the like.

Patent Literature 1 (Published Japanese Translation of PCT International Publication for Patent Application, No. 2018-523331) discloses a configuration of a system for controlling an unmanned vehicle using image data. The system disclosed in Patent Literature 1 generates image data by processing sensor data collected by using a LiDAR sensor. Furthermore, the system adjusts a resolution and the like of the image data. An operator monitoring an unmanned vehicle controls the unmanned vehicle by confirming the image data being adjusted the resolution or the like, for example, a 3D video.

### SUMMARY

Sensor data collected by using a LiDAR sensor are equivalent to point cloud data. In a case of generating image data for a 3D video from point cloud data by using the system disclosed in Patent Literature 1, when a shape of an object included in the point cloud data is indicated with high accuracy, a capacity of the image data increases. On the other hand, when accuracy of the shape of the object included in the point cloud data is reduced, the capacity of the image data decreases. However, when the accuracy of the shape of the object included in the point cloud data is reduced, it becomes difficult to accurately recognize the shape of the object. In this way, when the system disclosed in Patent Literature 1 is used, a problem that it is difficult to balance the capacity of the image data with the accuracy indicating the shape of the object when generating the image data from the point cloud data occurs.

An example object of the present disclosure is to provide an information processing apparatus, a data generation method, and a program that are capable of suppressing an increase in capacity and preventing a decrease in accuracy of a shape of an object when generating image data based on point cloud data.

In a first example aspect, an information processing apparatus according to the present disclosure includes: an identification unit configured to identify a shape of an object included in point cloud data; a generation unit configured to generate first mesh data of a first object whose shape is identified, and generate second mesh data of a second object whose shape is identified, by using a mesh resolution different from a mesh resolution used in generating the first mesh data; and an integration unit configured to generate three-dimensional data acquired by combining the first mesh data and the second mesh data.

In a second example aspect, a data generation method according to the present disclosure identifies a shape of an object included in point cloud data, generates first mesh data of a first object whose shape is identified, generates second mesh data of a second object whose shape is identified, by using a mesh resolution different from a mesh resolution used in generating the first mesh data, and generates three-dimensional data acquired by combining the first mesh data and the second mesh data.

In a third example aspect, a program according to the present disclosure causes a computer to execute: identifying a shape of an object included in point cloud data; generating first mesh data of a first object whose shape is identified; generating second mesh data of a second object whose shape is identified, by using a mesh resolution different from a mesh resolution used in generating the first mesh data; and generating three-dimensional data acquired by combining the first mesh data and the second mesh data.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a configuration diagram of an information processing apparatus according to the present disclosure;

FIG. 2 is a diagram illustrating a flow of processing of a data generation method according to the present disclosure;

FIG. 3 is a configuration diagram of the information processing apparatus according to the present disclosure;

FIG. 4 is a diagram illustrating management information managed by a management unit according to the present disclosure;

FIG. 5 is a diagram illustrating three-dimensional data displayed by a display unit according to the present disclosure;

FIG. 6 is a diagram illustrating a flow of display processing of three-dimensional data according to the present disclosure;

FIG. 7 is a diagram illustrating management information managed by the management unit according to the present disclosure;

FIG. 8 is a diagram illustrating a flow of display processing of three-dimensional data according to the present disclosure; and

FIG. 9 is a configuration diagram of the information processing apparatus according to the present disclosure.

### EXAMPLE EMBODIMENT

### First Example Embodiment

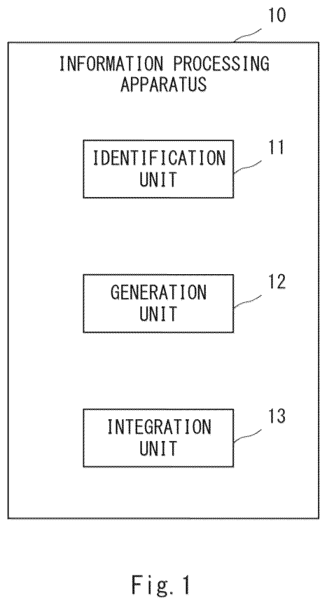

Hereinafter, a configuration example of an information processing apparatus 10 will be described with reference to FIG. 1. The information processing apparatus 10 may be a computer apparatus that operates by a processor executing a program stored in a memory.

The information processing apparatus 10 includes an identification unit 11, a generation unit 12, and an integration unit 13. Each of the identification unit 11, the generation unit 12, and the integration unit 13 may be software or a module that executes processing by a processor executing a program stored in a memory. Alternatively, each of the identification unit 11, the generation unit 12, and the integration unit 13 may be hardware such as a circuit or a chip.

The identification unit 11 identifies a shape of an object included in point cloud data. The point cloud data are a set of points having three-dimensional information. The point cloud data may be generated, for example, by a sensor measuring a distance or an imaging apparatus. The sensor measuring a distance may be, for example, a sensor measuring a distance from the sensor to an object by using light detection and ranging (LIDAR). The point cloud data may be generated by using distance information measured at the sensor measuring a distance and position information measured by using a global positioning system (GPS).

Various sensors that generate the point cloud data may be mounted in the information processing apparatus 10, or may be connected to the information processing apparatus 10 via a network. The identification unit 11 acquires the point cloud data generated by various sensors.

Alternatively, a user may input the point cloud data generated by various sensors to the information processing apparatus 10 as offline data. Further, the identification unit 11 may generate the point cloud data by using data measured by various sensors.

For example, the point cloud data may be generated by using software or the like that generates three-dimensional information by using a plurality of pieces of two-dimensional image data.

An object included in the point cloud data may be, for example, an object fixedly installed on the ground or a floor, or may be a movable object. Further, the object may include a human, an animal other than a human, a plant, and the like. Specifically, the object may be an apparatus, a component, or the like arranged in a substation.

Identifying a shape of an object may be determining a point indicating an outline of the object. Furthermore, identifying a shape of an object may be determining a point indicating a surface of the object in addition to the outline of the object.

The generation unit 12 generates first mesh data of a first object whose shape is identified. The mesh data are data indicating a solid shape with a point included in the point cloud data as a vertex, and a triangular surface or a quadrangular surface acquired by combining each of the vertexes as a surface of an object. The mesh data may be referred to as, for example, a mesh model, polygon data, object data, or the like. The mesh data, the mesh model, the polygon data, the object data, and the like are data indicating a three-dimensional shape of an object.

The generation unit 12 generates the first mesh data by using a mesh resolution. The mesh resolution may be, for example, a parameter that defines accuracy of a shape of an object. For example, as the mesh resolution increases, the shape of the object indicated by the mesh data becomes clear. A fact that a shape of an object becomes clear may be a fact that a boundary with a background or another object is clearly displayed. Further, a fact that a shape of an object becomes clear may be a fact that a reproduction degree indicating an actual object is high. A boundary between an object and a background or another object may be referred to as an edge of the object.

As the mesh resolution decreases, the shape of the object indicated by the mesh data becomes unclear. A fact that a shape of an object becomes unclear may be a fact that a boundary with a background or another object becomes ambiguous or blurred. A fact that a shape of an object becomes unclear may be a fact that a line indicating a boundary of the object becomes obscure. Further, a fact that a shape of an object becomes unclear may be a fact that the reproduction degree indicating an actual object is low.

The generation unit 12 further generates second mesh data of a second object by using a mesh resolution different from a mesh resolution used in generating the first mesh data. In other words, the generation unit 12 may determine the mesh resolution to be used in generating the mesh data for each object whose shape is identified. Alternatively, the generation unit 12 may determine the mesh resolution to be used in generating the mesh data for each group including some of objects. For example, objects of the same type may be included in one group. Alternatively, a plurality of types of objects constituting one apparatus may be included in one group.

The integration unit 13 generates three-dimensional data acquired by combining the first mesh data and the second mesh data. The three-dimensional data may be image data indicating a three-dimensional shape. The three-dimensional data include a plurality of pieces of mesh data generated by using different mesh resolutions. In other words, the three-dimensional data may include mesh data generated by using a mesh resolution higher than a predetermined reference and mesh data generated by using a mesh resolution lower than the predetermined reference.

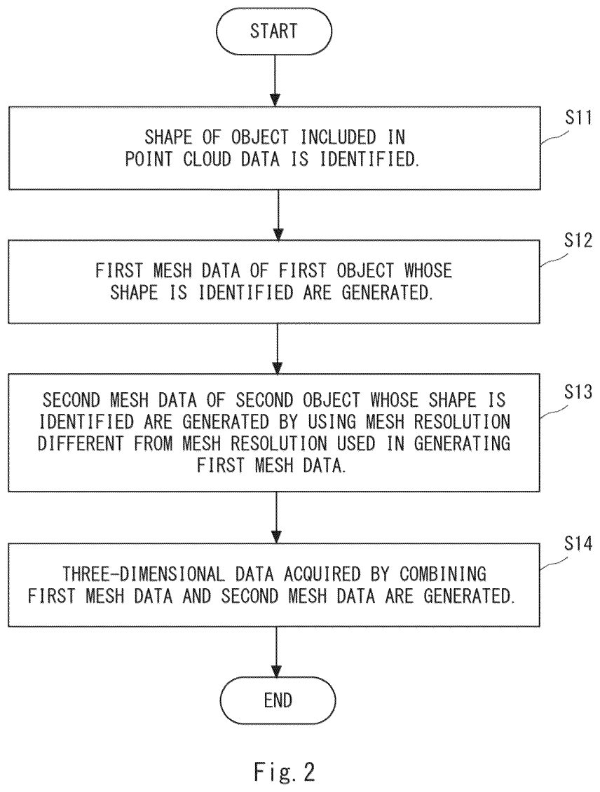

Subsequently, a flow of processing of data generation method executed in the information processing apparatus 10 will be described with reference to FIG. 2. First, the identification unit 11 identifies a shape of an object included in point cloud data (S11). Next, the generation unit 12 generates first mesh data of a first object whose shape is identified (S12). Next, the generation unit 12 generates second mesh data of a second object whose shape is identified, by using a mesh resolution different from a mesh resolution used in generating the first mesh data (S13). Next, the integration unit 13 generates three-dimensional data acquired by combining the first mesh data and the second mesh data (S14).

As described above, the information processing apparatus 10 generates three-dimensional data including mesh data of a plurality of objects by using different mesh resolutions. For all objects, a capacity of three-dimensional data including mesh data generated by using a high resolution and low resolution becomes smaller as compared with a capacity of three-dimensional data including mesh data generated by using the high resolution. Herein, the high resolution and the low resolution may be a high resolution or a low resolution as compared with a resolution of a predetermined reference. Alternatively, the high resolution and the low resolution may be a high resolution or a low resolution as compared with the other resolution.

Further, an object indicated by the mesh data generated by using the high resolution is clearly indicated in shape than an object indicated by the mesh data generated by using the low resolution. Thus, for example, when a user or the like decides normality of an object, based on a shape of the object, it is possible to appropriately decide the normality of the object indicated by the mesh data generated by using the high resolution.

### Second Example Embodiment

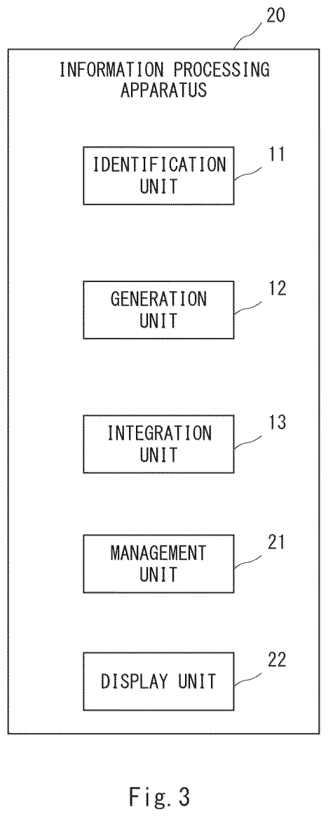

Subsequently, a configuration example of an information processing apparatus 20 will be described with reference to FIG. 3. The information processing apparatus 20 has a configuration in which a management unit 21 and a display unit 22 are added to the information processing apparatus 10. Constituent elements of the information processing apparatus 20 may be software that executes processing by a processor executing a program stored in a memory. Alternatively, the constituent elements of the information processing apparatus 20 may be hardware such as a circuit or a chip. Hereinafter, description of a similar function or operation to that of the information processing apparatus 10 will be omitted.

An identification unit 11 determining, from point cloud data, a shape of an object included in the point cloud data by using a learning model in which the shape of the object has been learned. Determining a shape of an object may be referred to as extracting, outputting, deciding, and the like the shape of the object.

The learning model may perform machine learning on a shape of an object by using point cloud data indicating the shape of the object as teacher data. The learning model may output point cloud data indicating a shape of an object by using point cloud data generated by a sensor by using LiDAR as an input. When shapes of a plurality of objects are learned by using point cloud data indicating the shapes of the plurality of objects as the teacher data, the learning model may output a plurality of pieces of point cloud data indicating the shapes of the plurality of objects included in the point cloud data. The learning model may learn, for example, a shape of a substation facility installed in a substation.

Furthermore, the learning model may perform machine learning on a shape of an object and a name of the object by using the shape of the object and the name of the object as the teacher data. In this case, the learning model may output the shape of the object and the name of the object by using the point cloud data as an input.

The identification unit 11 may determine a shape of an object by using a semantic segmentation as the determination of the shape of the object using the learning model.

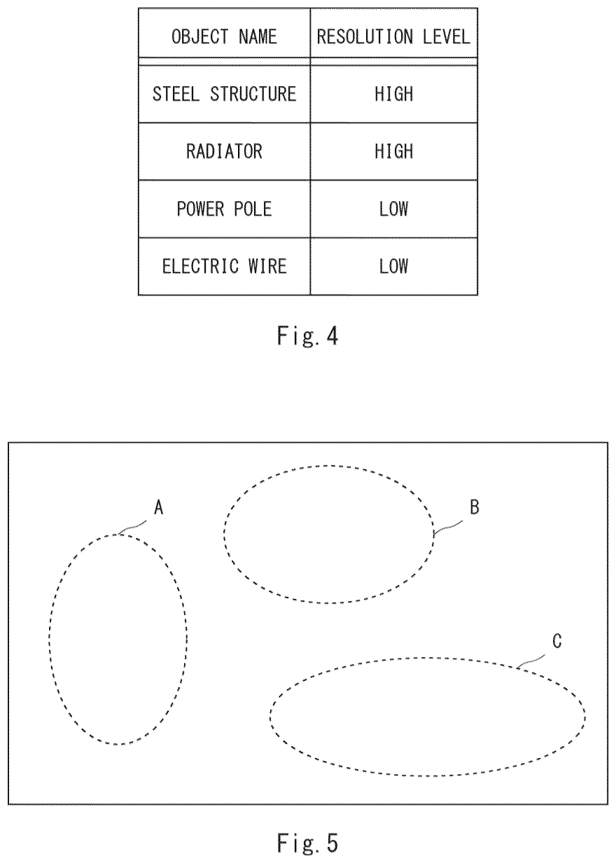

The management unit 21 manages a parameter defining a mesh resolution associated with an object included in point cloud data. Herein, management information managed by the management unit 21 will be described with reference to FIG. 4. FIG. 4 illustrates that an object name and a parameter indicating a resolution level are managed in association with each other in advance.

The object name is a name of an object included in the point cloud data. The object name may be a name of the object identified by the identification unit 11. FIG. 4 illustrates a substation facility installed in a substation as the object name.

In FIG. 4, “HIGH” and “LOW” are illustrated as resolution levels. The resolution level “HIGH” indicates a high resolution. Further, the resolution level “LOW” indicates a low resolution level. The resolution level may be indicated as “HIGH” when the resolution is higher than a predetermined reference, and may be indicated as “LOW” when the resolution is lower than the predetermined reference. Alternatively, when there are two different resolution levels, the higher resolution level may be indicated as “HIGH” and the lower resolution level may be indicated as “LOW”. Further, although two resolution levels are illustrated in FIG. 4, three or more resolution levels may be defined.

Association between the object name and the resolution level may be performed, for example, based on information input by an operator of the information processing apparatus 20. Specifically, an operator may input a mesh resolution used in generating mesh data of each object to the information processing apparatus 20. For example, an operator may set the resolution level for each object while confirming the object name displayed on a display.

Alternatively, the management unit 21 may acquire, via a network, information in which the object name and the resolution level are associated with each other stored in another information processing apparatus or the like, or may acquire information in which the object name and the resolution level are associated with each other offline.

A generation unit 12 determines the mesh resolution associated with the object identified by the identification unit 11 by using the management information managed by the management unit 21. The generation unit 12 generates mesh data of the object by using the mesh resolution previously associated with the object identified by the identification unit 11.

When the object identified by the identification unit 11 is not managed by the management unit 21, the generation unit 12 may generate mesh data by using a predetermined mesh resolution. The predetermined mesh resolution may be a mesh resolution indicated as “HIGH”, a mesh resolution indicated as “LOW”, or a mesh resolution of a level between “HIGH” and “LOW”.

Herein, the mesh resolution will be described in detail. The mesh resolution may define, for example, a distance between two points at a plurality of points used for mesh data. As the distance between the two points becomes shorter, the number of points used in the mesh data increases. As the distance between the two points becomes longer, the number of points used in the mesh data decreases. In other words, as the distance between the two points becomes shorter, a data capacity of the mesh data increases. As the distance between the two points becomes longer, the data capacity of the mesh data decreases. In other words, as the distance between the two points becomes shorter, accuracy indicating an object by the mesh data improves. As the distance between the two points becomes longer, accuracy indicating an object by the mesh data is reduced.

Alternatively, the mesh resolution may be defined an upper limit number of the number of points used for the mesh data in an area of a predetermined size. In other words, the mesh resolution may be defined an upper limit of density of points in an area of a predetermined size.

Returning back to FIG. 3, the display unit 22 displays three-dimensional data in which mesh data of each objects generated by using mesh resolutions of different levels are integrated. The display unit 22 may be, for example, a display used integrally with the information processing apparatus 20, or may be a display connected to the information processing apparatus 20 via a cable, a network, or the like. When the three-dimensional data are generated by integrating the mesh data of each of the objects, an integration unit 13 outputs the generated three-dimensional data to the display unit 22. The display unit 22 displays the received three-dimensional data.

FIG. 5 illustrates one example of three-dimensional data displayed by the display unit 22. It is assumed that mesh data of an object is indicated in an area A, an area B, and an area C surrounded by a dotted line. Further, the mesh resolutions used in generating the mesh data of each of the objects included in the areas A to C may be different from each other. For example, the areas A and B may be mesh data generated by using the same mesh resolution, and the area C may be mesh data generated by using a mesh resolution different from that of the areas A and B. The dotted line representing the areas A to C is a dotted line used for convenience to easily describe a position of the area, and an actual three-dimensional data displayed on the display unit 22 may not display the dotted line, and only the mesh data of the object included in the dotted line may be displayed.

The display unit 22 may display the mesh data of each of the objects included in the areas A to C without distinguishing a difference in the mesh resolution. In this case, a user who has visually recognized the three-dimensional data displayed on the display unit 22 cannot recognize the difference in the mesh resolution used in generating the mesh data of each of the objects in the areas A to C, or can recognize the difference in the mesh resolution by sharpness of a boundary of the object.

Alternatively, the display unit 22 may display the mesh data of each of the objects included in the areas A to C by distinguishing the difference in the mesh resolution. For example, the display unit 22 may make color of the mesh data of the object generated by using the same mesh resolution the same. In other words, the display unit 22 may change the color of the mesh data generated for each mesh resolution. For example, the display unit 22 may set the mesh data of the object generated by the mesh resolution having the resolution level of “HIGH” to red, and set the mesh data of the object generated by the mesh resolution having the resolution of “LOW” to blue. A type of color is merely exemplification, and the color used is not limited thereto.

Alternatively, as illustrated in FIG. 5, the display unit 22 may display a dotted line surrounding the object. Furthermore, the display unit 22 may change color of the dotted line surrounding the object for each mesh resolution used in generating the mesh data of the object. For example, the display unit 22 may set the dotted line surrounding the mesh data of the object generated by the mesh resolution having the resolution level of “HIGH” to red. Furthermore, the display unit 22 may set the dotted line surrounding the mesh data of the object generated by the mesh resolution having the resolution level of “LOW” to blue. The type of color is merely exemplification, and the color used is not limited thereto. Further, the dotted line surrounding the mesh data of the object may be a solid line.

Alternatively, the display unit 22 may change a type of the line surrounding the object or a thickness of the line for each mesh resolution used in generating the mesh data of the object.

The integration unit 13 may generate three-dimensional data that distinguishes the mesh data of the object by a difference in mesh resolution. Alternatively, when the display unit 22 displays the three-dimensional data received from the integration unit 13, the mesh data of the object may be displayed in such a way as to be distinguished by the difference in mesh resolution.

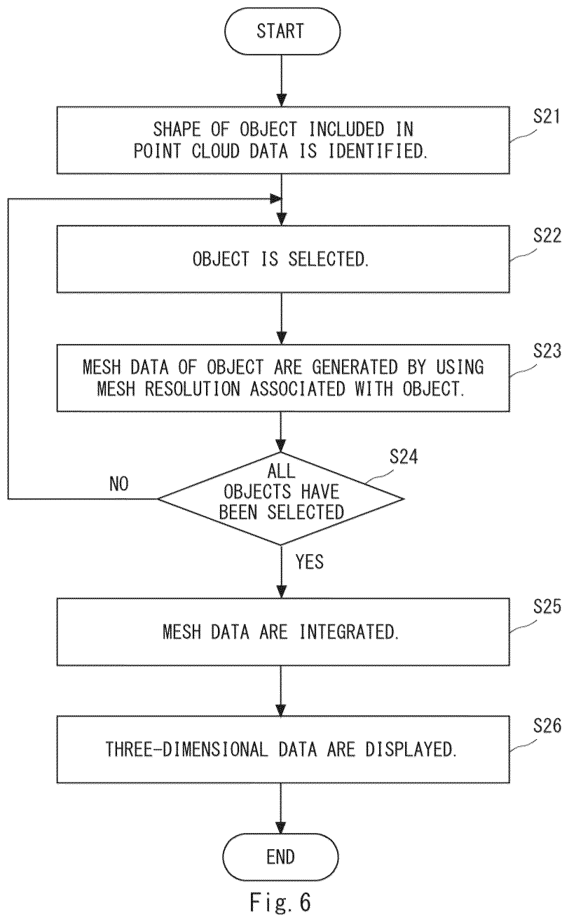

Subsequently, a flow of display processing of three-dimensional data executed in the information processing apparatus 20 will be described with reference to FIG. 6. First, the identification unit 11 identifies a shape of an object included in point cloud data (S21). Next, the generation unit 12 selects an object for generating mesh data (S22). The point cloud data include a plurality of objects. Thus, the identification unit 11 identifies or extracts a plurality of objects. The generation unit 12 selects one object from among the plurality of objects identified or extracted by the identification unit 11.

Next, the generation unit 12 generates mesh data of the selected object by using a mesh resolution of a resolution level associated with the selected object (S23). The generation unit 12 decides the resolution level associated with the selected object by using the management unit 21. The generation unit 12 may temporarily record the generated mesh data in a memory or the like in the information processing apparatus 20.

Next, the generation unit 12 decides whether all objects have been selected (S24). For example, the identification unit 11 may generate information indicating a list of all the identified objects, for example, list information. The generation unit 12 may add information indicating whether each of the objects included in the list information has been selected in step S22. For example, the generation unit 12 may set, in the list information, a checked flag to the object selected in step S22. The generation unit 12 may decide whether all objects have been selected by deciding whether information indicating selected has been added to each of the objects.

When it is decided in step S24 that all objects have not been selected, the generation unit 12 repeats processing in step S22 and subsequent steps. A fact that all objects have not been selected means that there is an unselected object. When the processing in step S22 is repeated, the generation unit 12 selects an unselected object.

When the generation unit 12 decides in step S24 that all objects have been selected, the integration unit 13 integrates the mesh data of all the objects (S25). Integrating the mesh data of all objects means combining the mesh data of all objects. When combining the mesh data, the integration unit 13 may generate three-dimensional data in which the mesh data are combined in such a way as to distinguish a difference in the mesh resolution being used. Next, the display unit 22 displays the generated three-dimensional data (S26).

As described above, the information processing apparatus 20 previously associates a resolution level with each of objects included in point cloud data. For example, when a manager or the like of a substation monitors a substation facility in the substation by using three-dimensional image data, the management unit 21 may manage a facility to be monitored, a facility that needs to confirm a detailed shape, and the like in association with a high resolution level. Further, the management unit 21 may manage a facility or the like not to be monitored in association with a low resolution level. As a result, it is possible to suppress an increase in a data capacity of the three-dimensional data as compared with a case where mesh data of all objects are generated by using a mesh resolution of the high resolution level. On the other hand, the mesh data of an object to be monitored is generated by using the mesh resolution of the high resolution level, and thus display accuracy of a shape of the object can be improved.

Further, the information processing apparatus 20 may display the mesh data generated by using the mesh resolutions of different resolution levels by distinguishing the mesh data. As a result, a manager or the like can easily determine a facility to be monitored.

### Third Example Embodiment

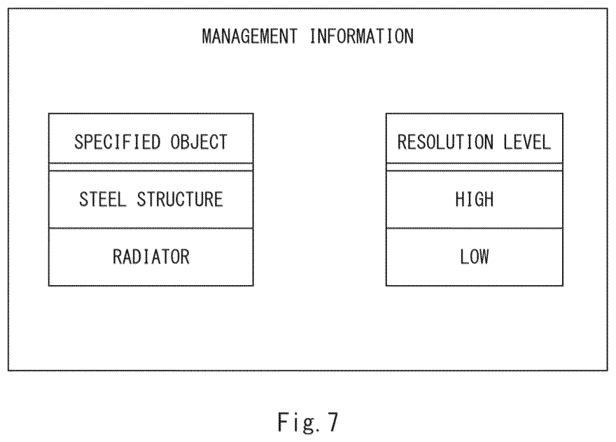

Subsequently, management information managed by a management unit 21 will be described with reference to FIG. 7. FIG. 7 illustrates that the management information includes an object specified by a manager or the like as a facility to be monitored. Furthermore, FIG. 7 illustrates that the management information includes a mesh resolution of “HIGH” and “LOW” as a resolution level. Although two resolution levels are illustrated in FIG. 7, three or more resolution levels may be defined.

When a selected object is included in the management information, a generation unit 12 generates mesh data by using a mesh resolution having a resolution level of “HIGH” for the selected object. Further, when the selected object is not included in the management information, the generation unit 12 generates mesh data by using a mesh resolution having a resolution level of “LOW” for the selected object.

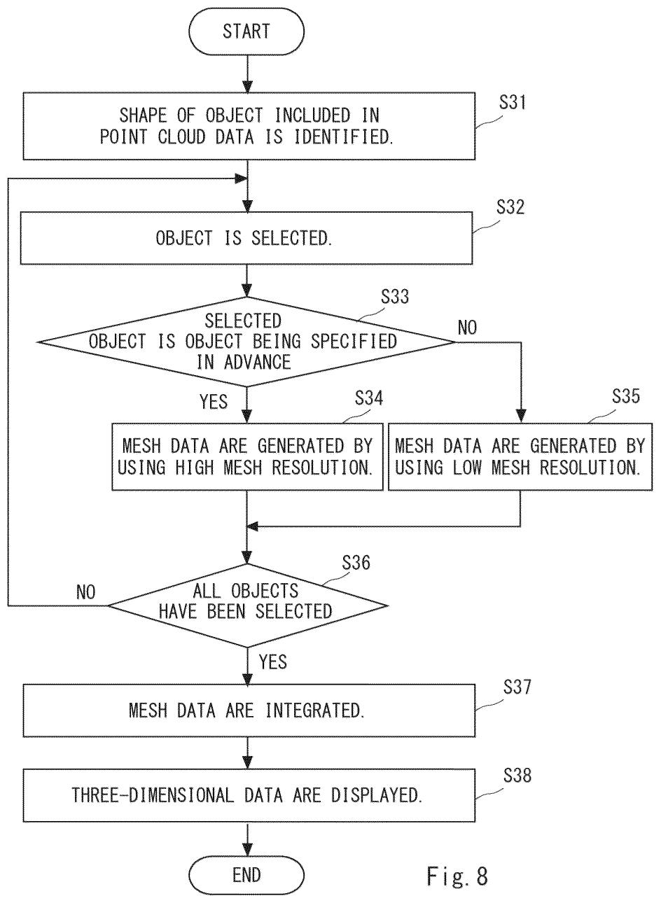

Subsequently, a flow of display processing of three-dimensional data executed in an information processing apparatus 20 will be described with reference to FIG. 8. Steps S31 and S32 are similar to steps S21 and S22 in FIG. 6, and thus detailed description thereof will be omitted.

Next, the generation unit 12 decides whether an object selected in step S32 is an object being specified in advance (S33). When management information managed by the management unit 21 includes the object selected in step S32, the generation unit 12 may decide that the selected object is the object being specified in advance. Further, when the management information managed by the management unit 21 does not include the object selected in step S32, the generation unit 12 may decide that the selected object is not the object being specified in advance.

When deciding that the object selected in step S32 is the object being specified in advance, the generation unit 12 generates mesh data of the selected object by using the mesh resolution indicated as “HIGH” in the management information managed by the management unit 21 (S34).

When deciding that the object selected in step S32 is not the object being specified in advance, the generation unit 12 generates mesh data of the selected object by using the mesh resolution indicated as “LOW” in the management information managed by the management unit 21 (S35).

Processing in step S36 and subsequent steps is similar to the processing in step S24 and subsequent steps in FIG. 6, and thus a detailed description thereof will be omitted.

As described above, the management unit 21 manages a specified object and a resolution level as separate information without being associated with each other. As a result, it is possible to flexibly manage an object and the resolution level used in generating mesh data of the object as compared with a case where the object and the resolution level are managed in association with each other. For example, when the resolution level used in generating mesh data of a specified object is changed, a parameter specified in the resolution level may be changed. Alternatively, when an object using a mesh resolution having a resolution level of “HIGH” is changed, an object specified as the specified object may be changed. In this way, when a combination of an object and the resolution level is changed, it is not necessary to change the resolution level for each object.

Further, in the third example embodiment, when generating the mesh data of an object specified as a facility to be monitored, the mesh resolution indicated as “HIGH” is used. Furthermore, when generating the mesh data of an object not specified, the mesh resolution indicated as “LOW” is used. The association between an object and the mesh resolution is not limited thereto.

For example, the association between an object and the mesh resolution may be decided by using a learning model. For example, the learning model may be a model being performed machine learning in such a way as to decide an appropriate mesh resolution according to complexity of structure of an object. Specifically, the learning model may associate a high-resolution mesh resolution when the structure of the object is complicated, and associate a low-resolution mesh resolution when the structure of the object is simple.

The generation unit 12 may acquire the parameter of the mesh resolution associated with an input object by inputting the object whose shape is identified in an identification unit 11 into the learning model. By associating the object and the mesh resolution with each other in this way, it is possible to improve accuracy of a shape of an object indicated by the mesh data by using the high-resolution mesh resolution for an object having complicated structure. On the other hand, by using the low-resolution mesh resolution for an object having simple structure, a capacity of the mesh data can be reduced.

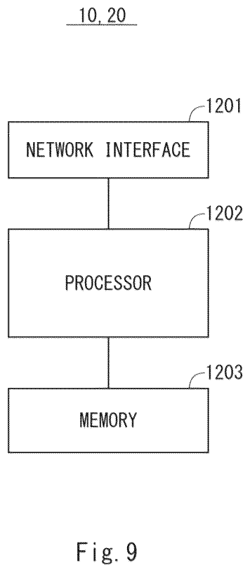

FIG. 9 is a block diagram illustrating a configuration example of the information processing apparatus 10 and the information processing apparatus 20 (hereinafter, referred to as the information processing apparatus 10 and the like) described in the above-described example embodiments. Referring to FIG. 9, the information processing apparatus 10 and the like include a network interface 1201, a processor 1202, and a memory 1203. The network interface 1201 may be used for communicating with a network node. The network interface 1201 may include, for example, a network interface card (NIC) compliant with IEEE 802.3 series. IEEE represents Institute of Electrical and Electronics Engineers.

The processor 1202 reads software (a computer program) from the memory 1203 and executes the read software, and thereby performs processing of the information processing apparatus 10 and the like described with reference to the flowchart in the above-described example embodiments. The processor 1202 may be, for example, a microprocessor, an MPU, or a CPU. The processor 1202 may include a plurality of processors.

The memory 1203 is configured by a combination of a volatile memory and a non-volatile memory. The memory 1203 may include a storage arranged away from the processor 1202. In this case, the processor 1202 may access the memory 1203 via a not-illustrated input/output (I/O) interface.

In the example in FIG. 9, the memory 1203 is used for storing a software module group. The processor 1202 can read the software module group from the memory 1203 and execute the read software module group, and thereby perform processing of the information processing apparatus 10 and the like described in the above-described example embodiments.

As described with reference to FIG. 9, each of the processors included in the information processing apparatus 10 and the like in the above-described example embodiments executes one or a plurality of programs including an instruction group for causing a computer to execute algorithm described with reference to the drawings.

In the examples described above, the program includes an instruction group (or a software code) that, when loaded into a computer, cause a computer to execute one or more of functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

An example advantage according to the above-described example embodiments is that it is possible to provide an information processing apparatus, a data generation method, and a program that are capable of suppressing an increase in capacity and preventing a decrease in accuracy of a shape of an object when generating image data based on point cloud data.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as the following supplementary notes, but are not limited thereto.

### (Supplementary Note 1)

An information processing apparatus including: an identification unit configured to identify a shape of an object included in point cloud data;
a generation unit configured to generate first mesh data of a first object whose shape is identified, and generate second mesh data of a second object whose shape is identified, by using a mesh resolution different from a mesh resolution used in generating the first mesh data; and
an integration unit configured to generate three-dimensional data acquired by combining the first mesh data and the second mesh data.

### (Supplementary Note 2)

The information processing apparatus according to supplementary note 1, wherein the generation unit generates mesh data of each object by using a mesh resolution associated with each object included in the point cloud data.

### (Supplementary Note 3)

The information processing apparatus according to supplementary note 1 or 2, wherein the generation unit generates mesh data by using a predetermined resolution when a mesh resolution is not associated with an object whose shape is identified.

### (Supplementary Note 4)

The information processing apparatus according to any one of supplementary notes 1 to 3, further including a management unit configured to manage a parameter defining a mesh resolution used for each of the objects.

### (Supplementary Note 5)

The information processing apparatus according to any one of supplementary notes 1 to 4, wherein the mesh resolution defines a distance between two points at a plurality of points used for mesh data.

### (Supplementary Note 6)

The information processing apparatus according to any one of supplementary notes 1 to 5, wherein the mesh resolution defines an upper limit number of points used in generating mesh data in a specific region.

### (Supplementary Note 7)

The information processing apparatus according to any one of supplementary notes 1 to 6, further including a display unit configured to display the three-dimensional data indicating that a resolution used for the first mesh data and a resolution used for the second mesh data are different from each other.

### (Supplementary Note 8)

The information processing apparatus according to any one of supplementary notes 1 to 7, wherein the identification unit determines, from the point cloud data, a shape of the object included in the point cloud data by using a learning model in which a shape of the object has been learned.

### (Supplementary Note 9)

The information processing apparatus according to supplementary note 8, wherein the learning model learns a shape of the object by using point cloud data indicating a shape of the object as teacher data.

### (Supplementary Note 10)

A data generation method including:
identifying a shape of an object included in point cloud data;
generating first mesh data of a first object whose shape is identified;
generating second mesh data of a second object whose shape is identified, by using a mesh resolution different from a mesh resolution used in generating the first mesh data; and
generating three-dimensional data acquired by combining the first mesh data and the second mesh data.

### (Supplementary Note 11)

The data generation method according to supplementary note 10, further including, when generating the first and second mesh data, generating mesh data of each object by using a mesh resolution associated with each object included in the point cloud data.

### (Supplementary Note 12)

The data generation method according to supplementary note 10 or 11, further including, when generating the first and second mesh data, generating mesh data by using a predetermined resolution when a mesh resolution is not associated with an object whose shape is identified.

### (Supplementary Note 13)

The data generation method according to any one of supplementary notes 10 to 12, wherein a parameter defining a mesh resolution used for each of the objects is managed by a management unit.

### (Supplementary Note 14)

The data generation method according to any one of supplementary notes 10 to 13, wherein the mesh resolution defines a distance between two points at a plurality of points used for mesh data.

### (Supplementary Note 15)

The data generation method according to any one of supplementary notes 10 to 14, wherein the mesh resolution defines an upper limit number of points used in generating mesh data in a specific region.

### (Supplementary Note 16)

The data generation method according to any one of supplementary notes 10 to 15, further including, after generating the three-dimensional data, displaying the three-dimensional data indicating that a resolution used for the first mesh data and a resolution used for the second mesh data are different from each other.

### (Supplementary Note 17)

The data generation method according to any one of supplementary notes 10 to 16, further including, when identifying a shape of an object included in the point cloud data, determining, from the point cloud data, a shape of the object included in the point cloud data by using a learning model in which a shape of the object has been learned.

### (Supplementary Note 18)

The data generation method according to supplementary note 17, wherein the learning model learns a shape of the object by using point cloud data indicating a shape of the object as teacher data.

### (Supplementary Note 19)

A program causing a computer to execute:
identifying a shape of an object included in point cloud data;
generating first mesh data of a first object whose shape is identified;
generating second mesh data of a second object whose shape is identified, by using a mesh resolution different from a mesh resolution used in generating the first mesh data; and
generating three-dimensional data acquired by combining the first mesh data and the second mesh data.

### (Supplementary Note 20)

The program according to supplementary note 19, further causing a computer to execute, when generating the first and second mesh data, generating mesh data of each object by using a mesh resolution associated with each object included in the point cloud data.

### (Supplementary Note 21)

The program according to supplementary note 19 or 20, further causing a computer to execute, when generating the first and second mesh data, generating mesh data by using a predetermined resolution when a mesh resolution is not associated with an object whose shape is identified.

### (Supplementary Note 22)

The program according to any one of supplementary notes 19 to 21, wherein a parameter defining a mesh resolution used for each of the objects is managed by a management unit.

### (Supplementary Note 23)

The program according to any one of supplementary notes 19 to 22, wherein the mesh resolution defines a distance between two points at a plurality of points used for mesh data.

### (Supplementary Note 24)

The program according to any one of supplementary notes 19 to 23, wherein the mesh resolution defines an upper limit number of points used in generating mesh data in a specific region.

### (Supplementary Note 25)

The program according to any one of supplementary notes 19 to 24, further causing a computer to execute, after generating the three-dimensional data, displaying the three-dimensional data indicating that a resolution used for the first mesh data and a resolution used for the second mesh data are different from each other.

### (Supplementary Note 26)

The program according to any one of supplementary notes 19 to 25, further causing a computer to execute, when identifying a shape of an object included in the point cloud data, determining, from the point cloud data, a shape of the object included in the point cloud data by using a learning model in which a shape of the object has been learned.

### (Supplementary Note 27)

The program according to supplementary note 26, wherein the learning model learns a shape of the object by using point cloud data indicating a shape of the object as teacher data.
10 INFORMATION PROCESSING APPARATUS
11 IDENTIFICATION UNIT
12 GENERATION UNIT
13 INTEGRATION UNIT
20 INFORMATION PROCESSING APPARATUS
21 MANAGEMENT UNIT
22 DISPLAY UNIT

What is claimed is:

1. An information processing apparatus comprising:
at least one memory storing instructions, and
at least one processor configured to execute the instructions to;
identify a shape of an object included in point cloud data;
generate first mesh data of a first object whose shape is identified, and generate second mesh data of a second object whose shape is identified, by using a mesh resolution different from a mesh resolution used in generating the first mesh data; and
generate three-dimensional data acquired by combining the first mesh data and the second mesh data.

2. The information processing apparatus according to claim 1, wherein the at least one processor is further configured to execute the instructions to generate mesh data of each object by using a mesh resolution associated with each object included in the point cloud data.

3. The information processing apparatus according to claim 2, wherein the at least one processor is further configured to execute the instructions to generate mesh data by using a predetermined resolution when a mesh resolution is not associated with an object whose shape is identified.

4. The information processing apparatus according to claim 1, wherein the at least one processor is further configured to execute the instructions to manage a parameter defining a mesh resolution used for each of the objects.

5. The information processing apparatus according to claim 1, wherein the mesh resolution defines a distance between two points at a plurality of points used for mesh data.

6. The information processing apparatus according to claim 1, wherein the mesh resolution defines an upper limit number of points used in generating mesh data in a specific region.

7. The information processing apparatus according to claim 1, wherein the at least one processor is further configured to execute the instructions to display the three-dimensional data indicating that a resolution used for the first mesh data and a resolution used for the second mesh data are different from each other.

8. The information processing apparatus according to claim 1, wherein the at least one processor is further configured to execute the instructions to determine, from the point cloud data, a shape of the object included in the point cloud data by using a learning model in which a shape of the object has been learned.

9. A data generation method comprising:
identifying a shape of an object included in point cloud data;
generating first mesh data of a first object whose shape is identified;
generating second mesh data of a second object whose shape is identified, by using a mesh resolution different from a mesh resolution used in generating the first mesh data; and
generating three-dimensional data acquired by combining the first mesh data and the second mesh data.

10. A non-transitory computer-readable storage medium storing a program causing a computer to execute:
identifying a shape of an object included in point cloud data;
generating first mesh data of a first object whose shape is identified;
generating second mesh data of a second object whose shape is identified, by using a mesh resolution different from a mesh resolution used in generating the first mesh data; and
generating three-dimensional data acquired by combining the first mesh data and the second mesh data.
